(19) United States
(12) Patent Application Publication
(10) Pub. No.: US 2016/0291830 A1
(43) Pub. Date: Oct. 6, 2016

(54) METHOD FOR LOCKING AND UNLOCKING AN ELECTRONIC DEVICE

(71) Applicant: I SHOU UNIVERSITY, Kaohsiung City (TW)

(72) Inventors: Po-Ying Chen, Kaohsiung City (TW); Shyh-Chang Liu, Kaohsiung City (TW)

(21) Appl. No.: 14/678,217

(22) Filed: Apr. 3, 2015

(51) Int. Cl. G06F 3/0488; G06F 21/36; G06F 3/0484

(52) U.S. Cl. CPC G06F 3/0488; G06F 3/04845; G06F 21/36

(57) ABSTRACT

A method for locking and unlocking an electronic device includes: displaying, on a touchscreen of the electronic device, a plurality of first visual objects and a plurality of second visual objects; upon detecting a contact with the touchscreen at a position corresponding to one of the first visual objects, while continuous contact with the touchscreen is detected, determining whether the continuous contact corresponds to a movement from the one of the first visual objects to one of the second visual objects; if affirmative, associating the one of the first visual objects with the one of the second visual objects, and locking the electronic device.

### FIELD

The disclosure relates to a method for locking and unlocking an electronic device.

### BACKGROUND

It has been widely known to have an electronic device locked after a predetermined time period of inactivity. When the electronic device is locked, access thereto is disabled and an unlocking process must be performed in order to gain access to the electronic device.

Examples of conventional means for unlocking an electronic device include entering a string of text serving as a password or providing a unique token such as a fingerprint. However it is noted that remembering passwords may be burdensome for some users, and passwords are susceptible from hacks. Using the token, on the other hand, requires a fair amount of processing (and time) in order to determine whether the token is authentic.

### SUMMARY

Therefore, an object of the disclosure is to provide a method for locking and unlocking an electronic device that includes a touchscreen. According to the disclosure, the method includes the steps of:

a) displaying on the touchscreen a plurality of first visual objects and a plurality of second visual objects;

b) upon detecting a contact with the touchscreen at a position corresponding to one of the first visual objects, while continuous contact with the touchscreen is detected, determining whether the continuous contact corresponds to a movement from said one of the first visual objects to one of the second visual objects;

c) if affirmative, associating said one of the first visual objects with said one of the second visual objects; and

d) locking the electronic device.

Another object of the disclosure is to provide a method for unlocking an electronic device that includes a touchscreen. According to the disclosure, the method includes the steps of:

a) displaying on the touchscreen a plurality of first visual objects and a plurality of second visual objects;

b) upon detecting contact with the touchscreen at a position corresponding to one of the first visual objects, while continuous contact with the touchscreen is detected, determining whether the continuous contact corresponds to a movement from said one of the first visual objects to an associated one of the second visual objects according to a preset criterion; and

c) if affirmative, unlocking the electronic device.

### BRIEF DESCRIPTION OF THE DRAWINGS

Other features and advantages of the disclosure will become apparent in the following detailed description of the embodiments with reference to the accompanying drawings, of which:

FIG. 1 is a flowchart illustrating steps of a locking process according to a first embodiment of the disclosure;

FIG. 2 illustrates an electronic device with a plurality of visual objects displayed on a touchscreen thereof;

FIG. 3 illustrates a plurality of associations between a plurality of first visual objects and corresponding second visual objects;

FIG. 4 illustrates one of the first visual objects being associated with one of the second visual objects;

FIG. 5 is a flowchart illustrating steps of an unlocking process according to the first embodiment; and

FIG. 6 illustrates the electronic device with a plurality of visual objects displayed on a touch screen thereof for use with a method according to a second embodiment of the disclosure.

### DETAILED DESCRIPTION

Before the disclosure is described in greater detail, it should be noted that like elements are denoted by the same reference numerals throughout the disclosure.

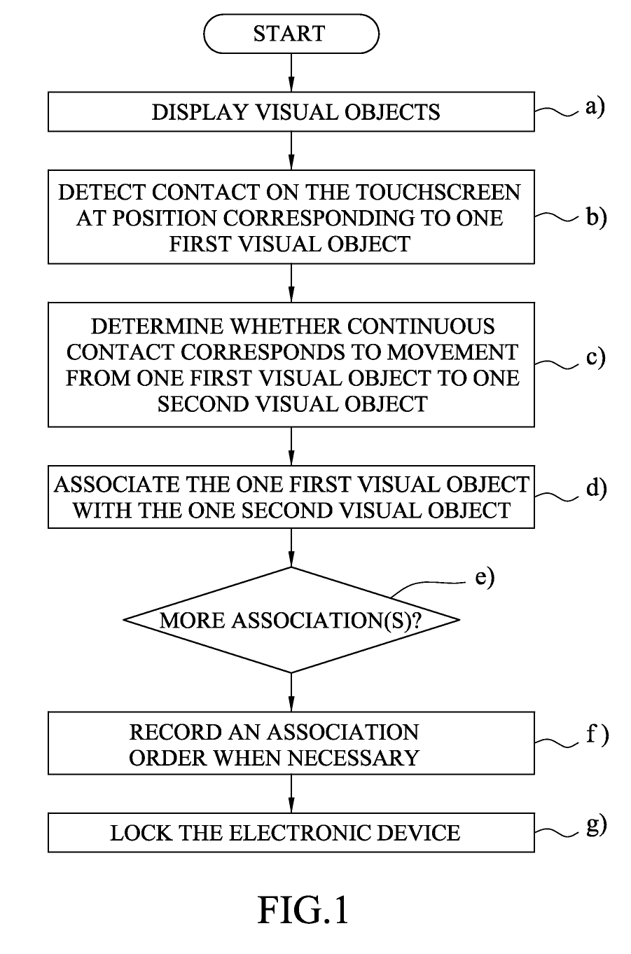

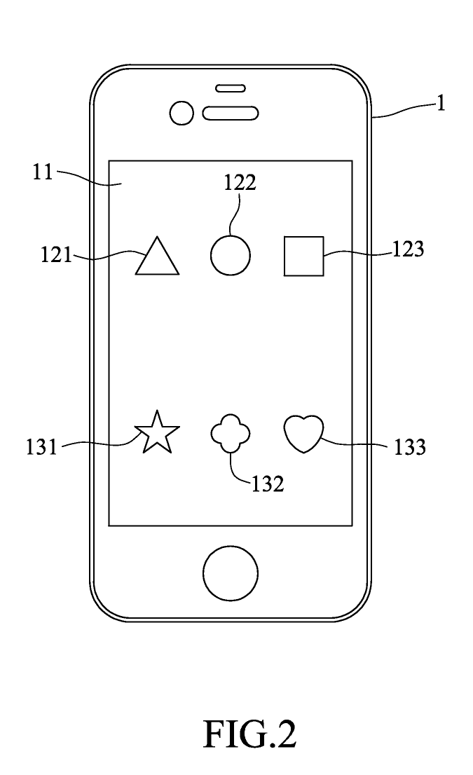

FIG. 1 is a flowchart illustrating steps of a method for locking and unlocking the electronic device 1 as shown in FIG. 2 according to a first embodiment of this disclosure. In the disclosure, the electronic device 1 includes a touchscreen 11, and may be embodied using a mobile phone, a laptop computer, a tablet computer, a personal digital assistant (PDA), a global positioning system (GPS) device, an e-book reader, a music player, a television with a touchscreen, etc. The electronic device 1 may be installed with an application that, when executed by a processor (not shown) of the electronic device 1 (e.g., by a user-input command), causes the electronic device 1 to implement a locking process for allowing a user to lock the electronic device 1.

In step a), the processor of the electronic device 1 controls the touchscreen 11 to display a plurality of first visual objects, and a plurality of second visual objects. In this embodiment, three first visual objects 121, 122, 123 and three second visual objects 131, 132, 133 are displayed (see FIG. 2), and the first and second visual objects (121 to 123, 131 to 133) displayed on the touchscreen 11 are different graphic patterns.

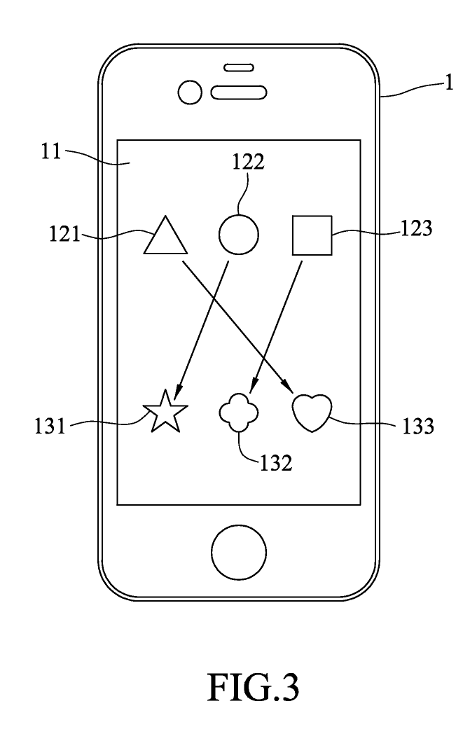

The first visual objects 121, 122, 123 and the second visual objects 131, 132, 133 may be aligned in corresponding rows. Specifically, the first visual objects 121, 122, 123 are arranged in a first row, and the second visual objects 131, 132, 133 are arranged in a second row spaced apart from the first row. In other embodiments, other manners may be employed in displaying the visual objects (e.g., arranged in columns). Meanwhile, an instruction may be displayed on the touchscreen 11 to notify a user to provide his/her preferred input for locking the electronic device 1. In this embodiment, the input may include a set of continuous contact(s) that corresponds to at least one movement from at least one of the first visual objects 121, 122, 123 to one of the second visual objects 131, 132, 133 (one such example is illustrated in FIG. 3).

Afterward, in step b), the touchscreen 11 detects a contact therewith at a position corresponding to one of the first visual objects 121, 122, 123. The user may use objects such as a finger or a stylus pen to contact the touchscreen 11.

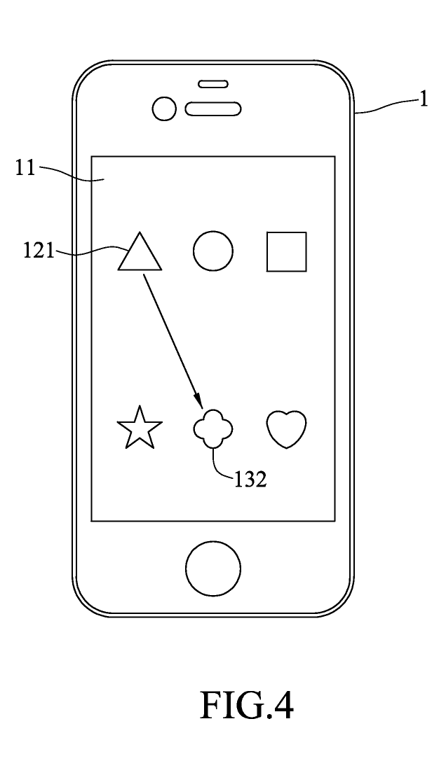

While continuous contact with the touchscreen 11 is detected, in step c), the processor determines whether the continuous contact corresponds to a movement from the one of the first visual objects 121, 122, 123 to one of the second visual objects 131, 132, 133. Meanwhile, the processor may “move” the one of the first visual objects 121, 122, 123 on the display of the touchscreen 11 to correspond to the movement of the continuous contact (as if the user is “dragging” the one of the first visual objects 121, 122, 123 around). In an example shown in FIG. 4, the first visual object 121 may be “moved” by the continuous contact toward the second visual objects 132, in a route indicated by the arrow.

If it is determined that the continuous contact corresponds to movement from the one of the first visual objects (e.g., 121) to one of the second visual objects (e.g., 132), in step d), the processor associates the one of the first visual objects 121 with the one of the second visual objects 132.

Afterward, in step e), the electronic device 1 stands by to allow the user to decide whether further associate(s) is required for his/her preferred input.

For example, a mechanism may be provided for confirming completion of the preferred input with a chosen number of association(s) having been made. Examples of the mechanism include, but are not limited to, user selection of a button on the touchscreen 11, and lapse of a predetermined period of inactivity. In response to the confirmation, the flow proceeds to step f).

Otherwise, in the case that the user “moves” another one of the first visual objects 121, 122, 123 toward another one of the second visual objects 131, 132, 133, the flow goes back to step b), and steps b) to d) are repeated before proceeding to step e) again.

In the example shown in FIG. 3, a total of three movements are performed by the user (i.e., each of the first visual objects 121, 122, 123 is “moved” along a respective one of the arrows toward one of the second visual objects 131, 132, 133). Afterward, in step f), the electronic device 1 stores an association order of the first visual objects 121, 122, 123 in which associations of the first visual objects 121, 122, 123 with the corresponding second visual objects 131, 132, 133 are made respectively in the consecutive instances of step d) (for example, in the order of 121 to 133, 122 to 131, and 123 to 132). It is noted that the association order is recorded only when necessary (i.e., in cases where multiple movements are performed).

Then, the flow proceeds to step g), in which the processor locks the electronic device 1. When the electronic device 1 is locked, certain operations associated with accessing the electronic device 1 are disabled.

It is noted that by the end of the locking process, the electronic device 1 has recorded therein a number of movement(s) (or association(s)) required for the preferred input, the association order if the number is more than one, and the association(s) between the first and second visual objects established in all instances of step d).

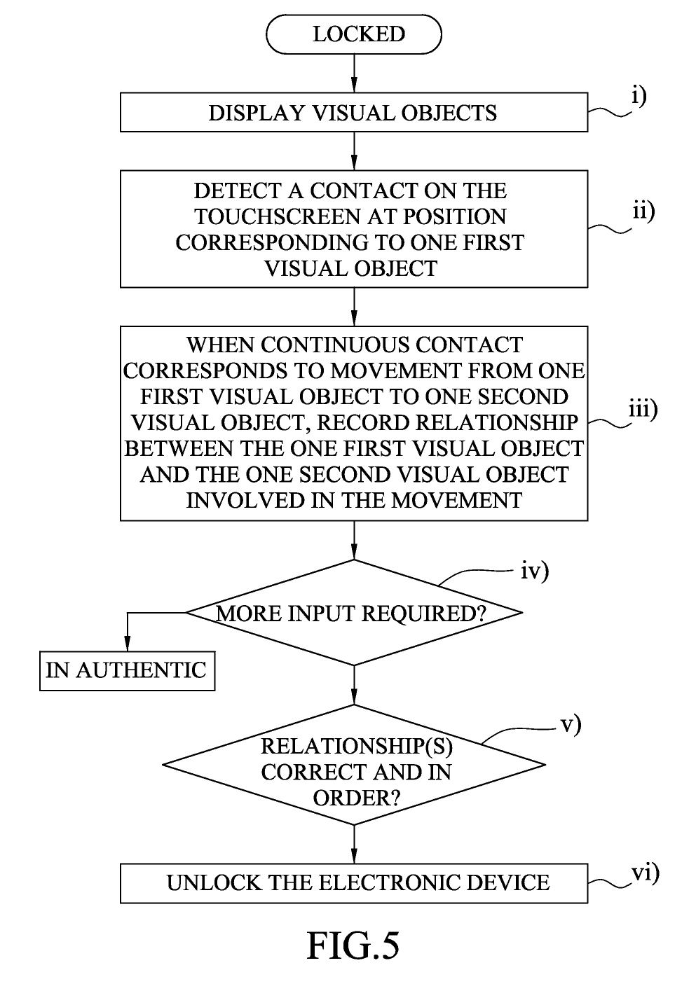

In order to unlock the electronic device 1, an unlocking process must be performed, in which the user is prompted for the preferred input as previously set. FIG. 5 is a flowchart illustrating steps of the unlocking process.

In response to an external attempt to access the electronic device 1 (e.g., the user pressing a button of the electronic device 1), in step i), the processor controls the touchscreen 11 to display the first visual objects 121, 122, 123 and the second visual objects 131, 132, 133 thereon.

In step ii), the touchscreen 11 detects a contact therewith at a position corresponding to one of the first visual objects 121, 122, 123. In step iii), while continuous contact with the touchscreen 11 is detected and corresponds to a movement from the one of the first visual objects 121, 122, 123 to one of the second visual objects 131, 132, 133, the processor records a relationship between the one of the first visual objects 121, 122, 123 to the one of the second visual objects 131, 132, 133 involved in the movement. Meanwhile, the process or may control the touchscreen 11 to continuously “move” the one of the first visual objects 121, 122, 123 on the touchscreen 11 in accordance with the movement of the continuous contact.

In step iv), the processor determines whether a number of times steps ii) and iii) have been performed reaches the number of movement(s) required for the preferred input as recorded in the electronic device 1. In the negative, the flow proceeds back to step ii) to await further user input. That is to say, steps ii) and iii) are to be repeated. On the other hand, if the determination in step iv) is affirmative, the flow goes to step v) as described below.

In step v), the processor determines whether the relationships between the moved one(s) of the first visual objects and the moved-to one(s) of the second visual objects as recorded in the instances of step iii) conform respectively with the associations recorded during the locking process and whether a movement order, in which the movements respectively from the first visual objects to the second visual objects are detected in the instances of step iii), is identical to the association order recorded for the locking process. That is to say, the processor determines, when at least one continuous contact with the touchscreen 11 is detected, whether the continuous contact(s) results in movement of each of the first visual objects 121, 122, 123 to an associated one of the second visual objects 131, 132, 133 and whether the movement order is identical to the association order.

Taking the preferred input that includes only a single association shown in FIG. 4 as an example, in the unlocking process, the processor only deems the movement of the first visual object 121 to the second visual object 132 as a correct unlocking operation. As a result, in response to said movement, the processor unlocks the electronic device 1.

Otherwise, the processor may control the touchscreen 11 to display a message notifying the user that the inputted movement is incorrect, and the electronic device 1 remains locked.

That is to say, the processor only unlocks the electronic device 1 when the following conditions are satisfied. First, each of the first visual objects 121, 122, 123 is moved to an associated one of the second visual objects 131, 132, 133. Second, a movement order of the first visual objects, in which the first visual objects 121, 122, 123 are moved respectively in the instances of step iii), is identical to the association order. The flow then proceeds to step vi), in which the electronic device 1 is unlocked.

Otherwise, when one of the movements is deemed incorrect, or when the movement order does not conform to the association order, the processor controls the touchscreen 11 to display the message notifying the user that the inputted input is false, and the electronic device 1 remains locked.

It is noted that, in step i) of the unlocking process, the first and second visual objects (121 to 123, 131 to 133) may be arranged in a manner that is different from that in step a) of the locking process for enhanced security.

A second embodiment according to the disclosure has a structure that is similar to the first embodiment.

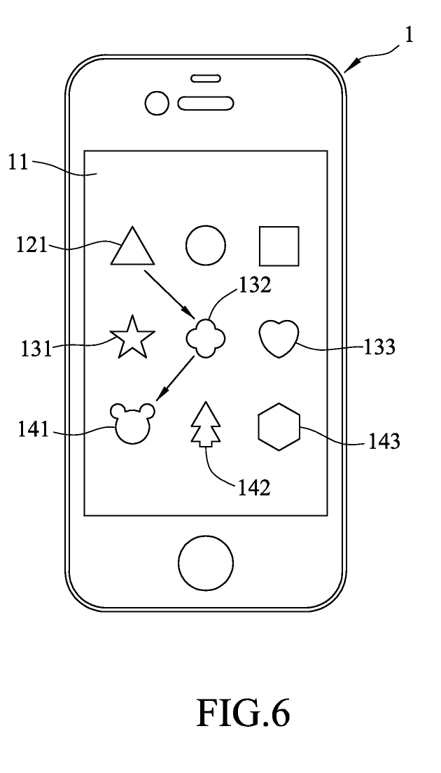

One main difference between this embodiment and the first embodiment is that in step a) of the locking process, the processor controls the touchscreen 11 to further display a plurality of third visual objects. In this embodiment, three different graphic patterns are displayed on a third row spaced apart from the first and second rows to serve as the third visual objects 141 to 143 (see FIG. 6).

Moreover, in step c) of the locking process, the continuous contact is required to correspond to movement from one of the first visual objects 121, 122, 123 to one of the second visual objects 131, 132, 133, and to one of the third visual objects 141, 142, 143. Accordingly, in step d), the processor associates the one of the first visual objects 121, 122, 123 to the one of the second visual objects 131, 132, 133 and the one of the third visual objects 141, 142, 143.

Accordingly, in step i) of the unlocking process, the processor controls the touchscreen 11 to further display the third visual objects 141 to 143.

In step iv), the processor deems the input correct when it is determined that a continuous contact with the touchscreen 11 is detected and corresponds to movement from the one of the first visual objects 121, 122, 123 through the associated one of the second visual objects 131, 132, 133 to the associated one of the third visual objects 141, 142, 143.

It should be noted herein that in some embodiments of this disclosure, steps a) to f) of the locking process may be performed only when the user wishes to set up the preferred input, and the electronic device 1 may be subsequently locked without inputting the preferred input, while only unlocking the electronic device 1 requires input of the preferred input. Alternatively, every time the user wishes to lock the electronic device 1 may be an opportunity to set up a new preferred input.

In embodiments of this disclosure, the application executed by the electronic device 1 may further provide the functionalities for the user to update the preferred input, to designate the graphic patterns of the visual objects, or to allow multiple users of the electronic device 1 to respectively create a unique unlocking operation associated with his/her account.

To sum up, the method of the disclosure provides a relatively easy way to setup a preferred input for unlocking the electronic device 1. It is noted that a human brain is able to remember an association between visual objects more easily than a string of text. Therefore, the preferred input thus created is less likely to be forgotten by the user. Moreover, since alphanumeric pass codes are not used for unlocking the electronic device 1, vulnerability to hacking is reduced (i.e., security is enhanced).

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for locking and unlocking an electronic device that includes a touchscreen, the method comprising the steps of:
a) displaying on the touchscreen a plurality of first visual objects and a plurality of second visual objects;
b) upon detecting a contact with the touchscreen at a position corresponding to one of the first visual objects, while continuous contact with the touchscreen is detected, determining whether the continuous contact corresponds to a movement from said one of the first visual objects to one of the second visual objects;
c) if affirmative, associating said one of the first visual objects with said one of the second visual objects; and
d) locking the electronic device.

2. The method of claim 1, further comprising the step of moving the first visual object on the display of the touchscreen to correspond to the movement of the continuous contact.

3. The method of claim 1, further comprising, after step d), the steps of:
displaying the first visual objects and the second visual objects on the touchscreen; and
unlocking the electronic device when a continuous contact with the touchscreen is detected and results in movement from said one of the first visual objects to said one of the second visual objects that is associated with said one of the first visual objects in step c).

4. The method of claim 1, wherein step d) is performed after repeating steps b) and c) to associate each of the first visual objects with one of the second visual objects,
wherein the method further comprises the step of storing an association order of the first visual objects in which associations of the first visual objects with the corresponding second visual objects are made respectively in the instances of step c).

5. The method of claim 4, further comprising, after step d), the steps of:
e1) displaying the first visual objects and the second visual objects on the touchscreen;
e2) upon detecting a contact with the touchscreen at a position corresponding to one of the first visual objects, while continuous contact with the touchscreen is detected and corresponds to a movement from said one of the first visual objects to one of the second visual objects, recording a relationship between said one of the first visual objects and said one of the second visual objects involved in the movement;
e3) repeating step e2); and
e4) unlocking the electronic device when it is determined that the relationships recorded in the instances of step e2) correspond to respectively the associations made in the instances of step c) and when a movement order, in which the movements respectively from the first visual objects to the second visual objects are detected in the instances of step e2), is identical to the association order.

6. The method of claim 1, wherein:
in step a), a plurality of third visual objects are further displayed on the touchscreen;
in step c), when the continuous contact results in movement from said one of the first visual objects through said one of the second visual objects to one of the third visual objects, said one of the first visual objects is further associated with said one of the third visual objects; and
step d) is performed after said one of the first visual objects is associated with said one of the second visual objects and with said one of the third visual objects.

7. The method of claim 6, further comprising, after step d), the steps of:
displaying the first, second and third visual objects on the touchscreen; and
unlocking the electronic device when a continuous contact with the touchscreen is detected and results in movement from said one of the first visual objects through said one of the second visual objects to said one of the third visual objects.

8. The method of claim 1, wherein the first visual objects are arranged in a first row, and the second visual objects are arranged in a second row spaced apart from the first row.

9. The method of claim 1, wherein the first and second visual objects displayed on the touchscreen are different graphic patterns.

10. A method for unlocking an electronic device that includes a touchscreen, the method comprising the steps of:
a) displaying on the touchscreen a plurality of first visual objects and a plurality of second visual objects;
b) upon detecting contact with the touchscreen at a position corresponding to one of the first visual objects, while continuous contact with the touchscreen is detected, determining whether the continuous contact corresponds to a movement from said one of the first visual objects to an associated one of the second visual objects according to a preset criterion; and
c) if affirmative, unlocking the electronic device.

11. The method of claim 10, wherein, in step c), the electronic device is unlocked when multiple continuous contacts correspond to respectively movements from the first visual objects to corresponding associated ones of the second visual objects.

12. The method of claim 10, further comprising the steps of:
displaying a plurality of third visual objects on the touchscreen;
in step b), while the continuous contact is detected, it is determined whether the continuous contact corresponds to a movement from said one of the first visual objects through said associated one of the second visual objects to an associated one of the third visual objects according to the preset criterion,
in step c), the electronic device is unlocked if the determination made in step b) is affirmative.

13. The method of claim 10, wherein the first visual objects are arranged in a first row, and the second visual objects are arranged in a second row spaced apart from the first row.

14. The method of claim 10, wherein the first and second visual objects displayed on the touchscreen are different graphic patterns.
